(19) United States
(12) Patent Application Publication
(10) Pub. No.: US 2012/0110453 A1
(43) Pub. Date: May 3, 2012

(54) Display of Image Search Results

(75) Inventors: Yue Ma, Bellevue, WA (US); Justin D. Hamilton, Bellevue, WA (US); Wallace Earl Greathouse, Provo, UT (US); Bao Tan Nguyen, Bellevue, WA (US); Avinash Vemuluru, Redmond, WA (US); Paul Valentin Borza, Bellevue, WA (US); Rajat Kala, Seattle, WA (US)

(73) Assignee: MICROSOFT CORPORATION, Redmond, WA (US)

(21) Appl. No.: 12/916,169

(22) Filed: Oct. 29, 2010

(51) Int. Cl. G06F 3/048

(52) U.S. Cl. 715/716; 715/838

(57) ABSTRACT

Techniques involving display of image search results are described. In one or more implementations, an image search result is displayed having a plurality of images. Responsive to selection of a particular one of the images, a filmstrip is displayed having a contiguous series of representations of at least a portion of the plurality of images, at least one of which is of the particular image, the particular image is displayed as disposed proximal to metadata associated with the image, and at least a portion of a webpage from which the particular image was obtained is displayed.

### BACKGROUND

To locate particular content, users may interact with a search engine which may provide one or more search results. Further, these search results may relate to a wide variety of content. However, traditional techniques that were utilized to provide and display search results may become limited when confronted with different types of content.

For example, traditional search results included links to websites with brief textual descriptions. These search results were typically provided in response to keywords in a search request. However, the techniques that were traditionally utilized to display these search results may be limited when confronted with other types of content, such as images.

### SUMMARY

Techniques involving display of image search results are described. In one or more implementations, an image search result is displayed having a plurality of images. Responsive to selection of a particular one of the images, a filmstrip is displayed having a contiguous series of representations of at least a portion of the plurality of images, at least one of which is of the particular image, the particular image is displayed as disposed proximal to metadata associated with the image, and at least a portion of a webpage from which the particular image was obtained is displayed.

In one or more implementations, a cursor is detected as positioned over a particular image in an image search result received from an Internet search service. Responsive to the detection, one or more options are displayed to navigate through the image search result.

In one or more implementations, a filmstrip is displayed having a contiguous series of representations of at least a portion of a plurality of images of an image search result, at least one of which is of a particular image. The particular image is displayed as disposed proximal to metadata associated with the image, the particular image displayed larger than the representation of the particular image in the filmstrip. At least a portion of a webpage from which the particular image was obtained is also displayed along with a link that is selectable to cause output of a related image search result. Responsive to detection that a cursor is positioned over the link, an image is displayed from the related image search result.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ the image search result techniques described herein.

FIG. 2 is an illustration of a user interface in an example implementation as displaying a plurality of images obtained in a search result from an Internet search service.

FIG. 3 is an illustration of a user interface in an example implementation as displaying an image search result at least in part using a filmstrip.

FIG. 4 is an illustration of a user interface in an example implementation as displaying options to navigate between images in an image search result.

FIG. 5 is an illustration of a user interface in an example implementation as displaying an image of a related image search result responsive to disposing a cursor over a link that is selectable to cause output of the related image search result.

FIG. 6 is a flow diagram depicting a procedure in an example implementation in which an image search result is configured to include a filmstrip.

FIG. 7 is a flow diagram depicting a procedure in an example implementation in which one or more options to navigate through an image search result are displayed responsive to detection of positioning of a cursor over an image.

FIG. 8 is a flow diagram depicting a procedure in an example implementation in which an image from a related image search result is output in responsive to positioning a cursor over a link.

### DETAILED DESCRIPTION

Overview

Traditional techniques to perform a search may be limited when confronted with different types of content. For example, traditional techniques that were utilized to search for a webpage may provide a search result that is difficult to decipher when providing results for an image search.

Techniques involving display of image search results are described. In one or more implementations, image search results are displayed as a filmstrip to enable a user to locate a particular image of interest quickly as well as to navigate through the images in an efficient manner.

For example, the filmstrip may include representations of images found in a search result. The image search result may also include a display of a selected image from the filmstrip separately in a larger view in comparison to the representation in the filmstrip, along with metadata from the image such as size of the image.

Further, the image search result may also display a webpage from which the image was taken. For instance, a portion of the webpage that includes the images may be displayed along with the image and the filmstrip. In this way, a user is provided with an overall view of the image search results and is able to view a selected image in greater detail, as well as view from “where” the image was obtained. A variety of other embodiments are also contemplated, further discussion of which may be found in relation to the following sections.

In the following discussion, an example environment is first described that is operable to perform image search result techniques described herein. Examples procedures are then described, which are operable in the example environment as well as in other environments. Likewise, the example environment is not limited to performance of the example procedures.

Example Environment

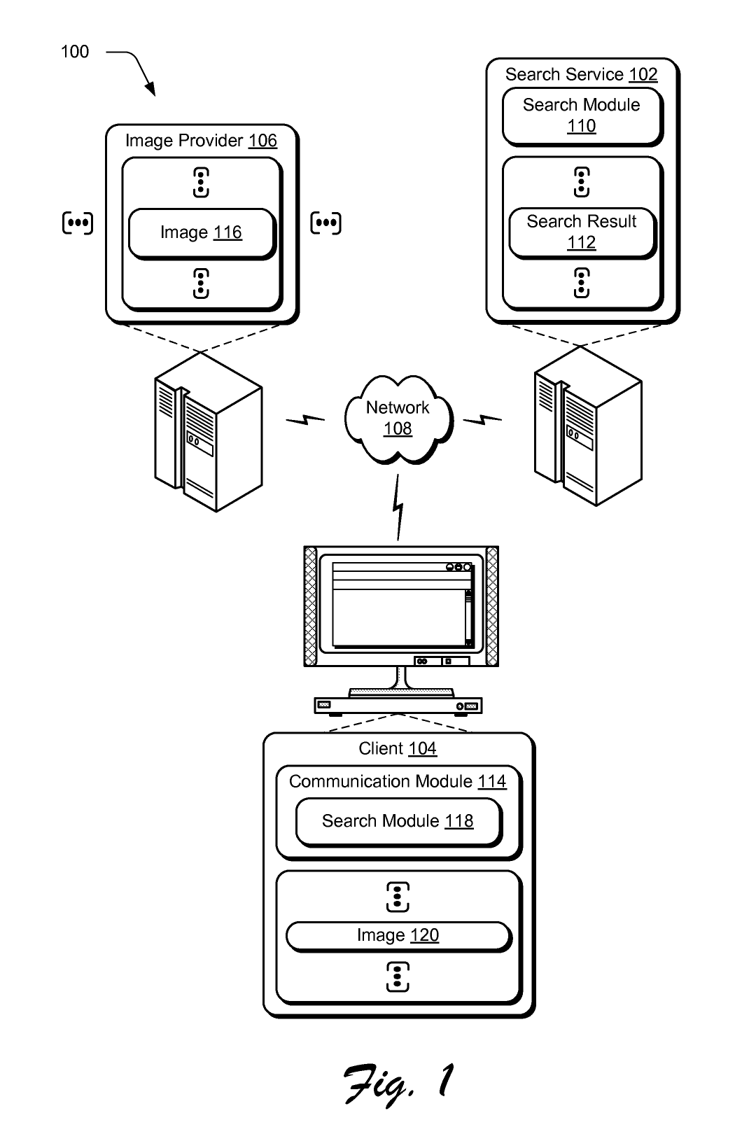

FIG. 1 is an illustration of an environment 100 in an example implementation that is operable to employ image search result techniques. The illustrated environment 100 includes a search service 102, a client 104, and an image provider 106, each of which are communicatively coupled, one to another, over a network 108.

Although the client 104 is illustrated as a client device (e.g., a traditional desktop computer) and the search service 102 and image provider 106 are illustrated as being implemented by one or more servers, these entities may be implemented by a variety of different devices. For example, the client 104 may be configured as a computer that is capable of communicating over the network 108, such as a desktop computer, a mobile station, an entertainment appliance, a set-top box communicatively coupled to a display device, a wireless phone, a game console, a tablet computer, a netbook, and so forth. Thus, the client 104 may range from a full resource device with substantial memory and processor resources (e.g., personal computers, game consoles) to a low-resource device with limited memory and/or processing resources (e.g., traditional set-top boxes, hand-held game consoles). The client 104 may also describe logical clients that include software and/or as well as hardware that is used to execute the software, e.g., one or more processors.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

The search service 102 is illustrated as including a search module 110. The search module 110 is representative of functionality to provide a search result 112 in response to a search query. For example, a user of the client 104 may interact with a communication module 114, which is representative of functionality of the client 104 to interact with the network 108, such as a browser over the Internet.

The search module 110 may employ a variety of different techniques to form a search result 112. For example, the search module 110 may employ one or more software robots (“bots”) to search and index content available over the Internet, such as images 116 from an image provider 106. These indexes may be based on keywords and other information. Further, a variety of different techniques may be employed to apply different weights to parts of the index such that a user has an increased likelihood of finding content of interest.

Traditional techniques that were utilized to display the search result 112, however, may be found lacking when confronted by different types of content, such as images 116. For example, traditional search results for webpages may be considered insufficient by typical users when applied to display search results for images. Accordingly, techniques are described that may be implemented by the search service 102, the communication module 114 of the client 104, and so on to display image search results. Thus, although the following discussion describes a search result provided by the search service 102, these techniques may be employed by a variety of different entities, such as a third-party service, locally by a search module 118 to search images 120 that are local to the client 104, and so on. Example search results and corresponding functionality may be found in relation to the example user interfaces that follow.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the image search result display techniques described below are platform-independent, meaning that the techniques may be implemented on a variety of commercial computing platforms having a variety of processors.

Example User Interfaces

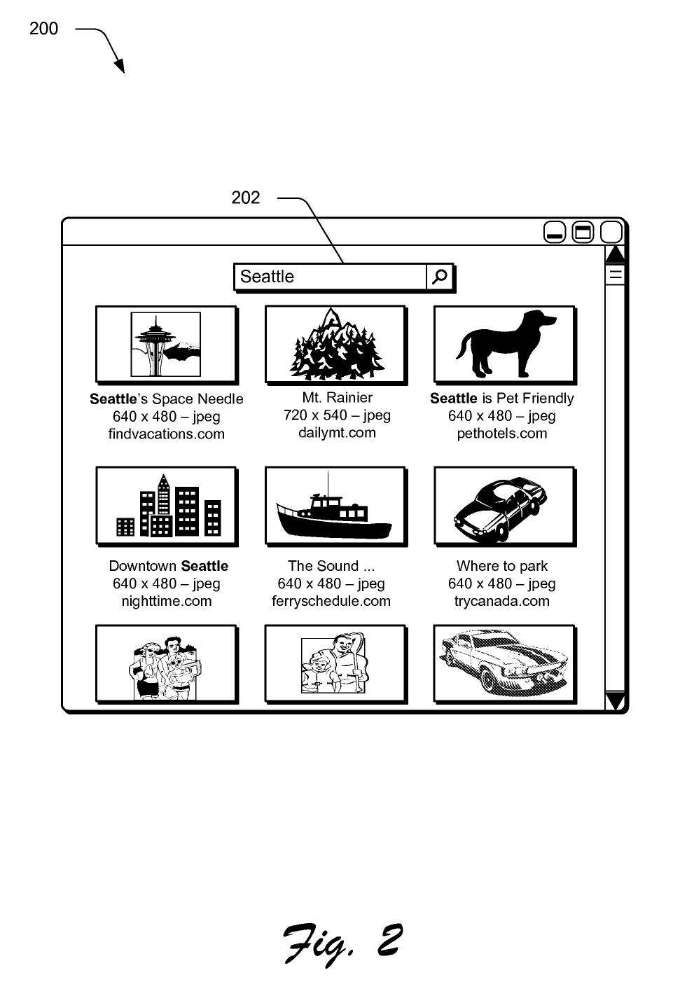

FIG. 2 is an illustration of a user interface 200 in an example implementation as displaying a plurality of images obtained in a search result from an Internet search service. In this example, the user interface 200 is output at the client 104 using functionality of the communication module 114. For example, the communication module 114 may include browser functionality to navigate to the search service 102 via the network 108 of FIG. 1, although other examples are also contemplated.

In the illustrated example, the user interface 200 includes a text entry portion that is configured to receive terms to be user in a search request, such as for a term “Seattle.” The user interface 200 also includes a plurality of images in a search result for the term “Seattle.” Example images include images of the Space Needle, Mt. Rainier, and so on. This user interface 200 may be displayed initially in response to a search request sent to the search service 102.

Thus, in this example, the images in the search result 112 are displayed following an arrangement as a grid with metadata that describes the image (which may be bolded to indicate inclusion of a search term), such as size, from where the image was obtained, and so on. In one or more implementations, the search result 112 employs links to link to the actual images so that the images are not copied by the search service 102. A user may then select one of the images, e.g., the image of a dog using a cursor control device, gesture (e.g., a tap), and so on, a result of which is shown in the following figure.

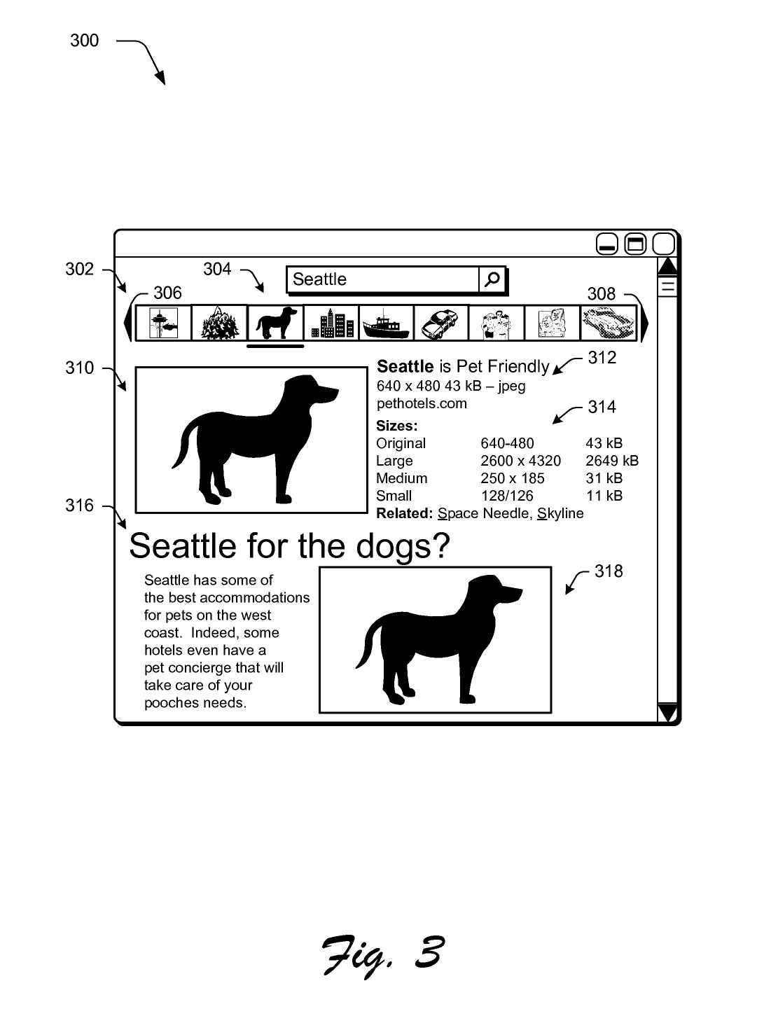

FIG. 3 is an illustration of a user interface 300 in an example implementation as displaying an image search result at least in part using a filmstrip. The user interface 304 in this example includes a filmstrip 302 having images that correspond to the search results in the user interface 200 of FIG. 2. For example, the filmstrip 302 may be formed as a contiguous series of representations of the images (e.g., may be hot linked) such that the representations connect without a break and may share a border with at least one other representation in the filmstrip. Further, the representations may be displayed in an order that follows the image search result of FIG. 2, which may be performed in order of determined relevancy using the search techniques previously described for the search service 102. In the illustrated implementation, the filmstrip includes a representation of the image selected in FIG. 2 and includes an indication of the selection, e.g., as an underline although other indicators are also contemplated.

The filmstrip 302 supports techniques such that a user may efficiently navigate through a large number of images to locate a particular image. A user, for instance, may scroll through the representations using a gesture, e.g., a tap and drag. In another instance, a user may select one or more of the opposing controls 306, 308 which are displayed as arrows to cause the filmstrip 302 to scroll in a corresponding direction by using a gesture, cursor control device, and so on. Further, the filmstrip 302 may give the user an impression of access to an “infinite” data store by continually populating the filmstrip with representations as it is scrolled without navigating through a series of pages of the search result as was done traditionally. In an implementation, the display of the image and the portion 316 remain “as is” without changing as the filmstrip 302 is scrolled until a representation in the filmstrip 302 is selected.

The user interface 300 also includes a display of the image 310 selected in FIG. 2. The image 310 may be displayed in a variety of ways, such as at an original size, at an original size up to a threshold amount to conserve space in the user interface 300, at a predetermined size, and so on. The image 310 in this example is displayed proximal to metadata 312 that is associated with the image, such as a size of the image, amount of memory space that would be used to store the image, a format of the image, and an indicator of a source of the image. A variety of other metadata is also contemplated.

The user interface 300 also includes a display of one or more options 314 to cause the image to be displayed in a different size. For example, the options 314 may include a large, medium, and small size. The options 314 may also include an original size of the image, such as to “return” to the original size after selection of the other sizes.

The user interface 300 further includes a display of at least a portion 316 of a webpage from which the image 310 originated. In an implementation, the portion 316 is selected to show the image 318 and thus give context to where the image was located in the webpage. Other implementations are also contemplated, such as to automatically display a top portion of the webpage.

Thus, in this example the user interface 300 follows a vertical arrangement in which the filmstrip is display horizontally across a top of the user interface 302. The selected image 310 is displayed below the filmstrip 302 along with information that relates to the image 310, e.g., metadata 312 and options 314 to display the image 310 in different sizes. The portion 316 of the webpage that originated the image 310 is then displayed below the image 310, and may also include a display of the image 318 for context. These features may be displayed concurrently, although other implementations are also contemplated. The image display techniques may also support a variety of other functionality, examples of which may be found in relation to the following figures.

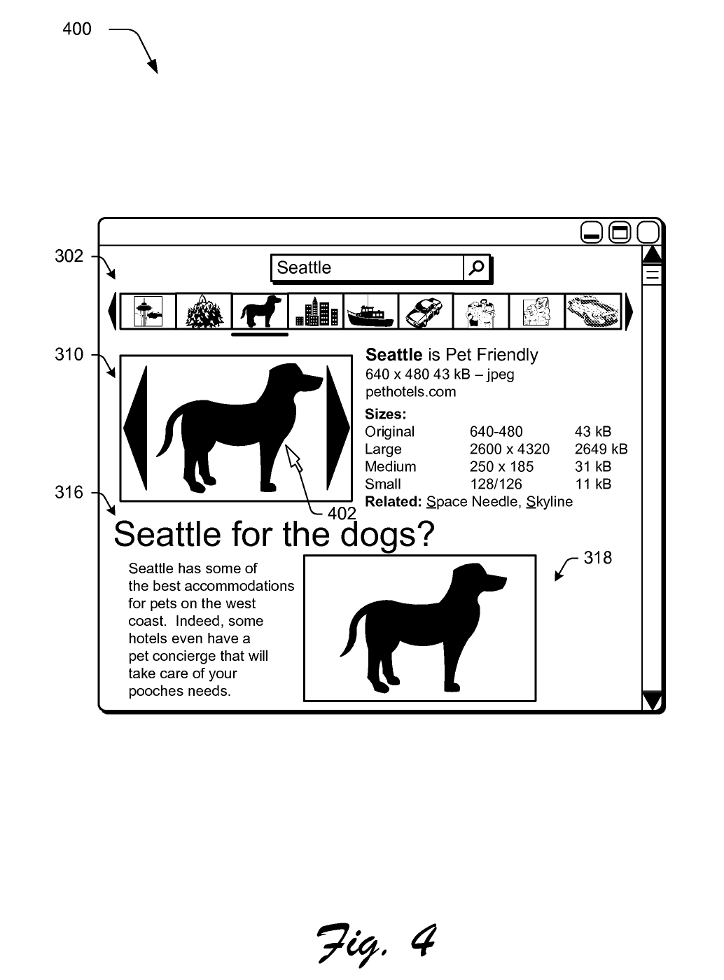

FIG. 4 is an illustration of a user interface 400 in an example implementation as displaying options to navigate between images in an image search result. In this example, a cursor 402 is displayed over the image 310 but has not selected the image by “clicking” it. In response to the placement of the cursor 402, options are displayed as arrows to navigate to another image using non-modal techniques. Selection of the arrow (e.g., by clicking the arrow) may cause the user interface 400 to display a next image in the filmstrip 302 that corresponds to the direction of the arrow selected. In this way, a user may readily navigate through the images without moving the cursor away from the image 310 or using one or more menus.

In an implementation, an animation is output during navigation between the images. For example, the image 310 may be displayed as “fading out” while a next image to be displayed “fades in.” A variety of other examples of animations are also contemplated.

Although the options are displayed with a boundary of the image 310, the options may be displayed in a variety of ways, such as proximal to the image “outside” the boundary, and so on. Further, although the image 310 was described in this example, this functionality may be employed by other images in the user interface 300, such as representations in the filmstrip 302, images 318 in the portion 316 of the webpage, and so on.

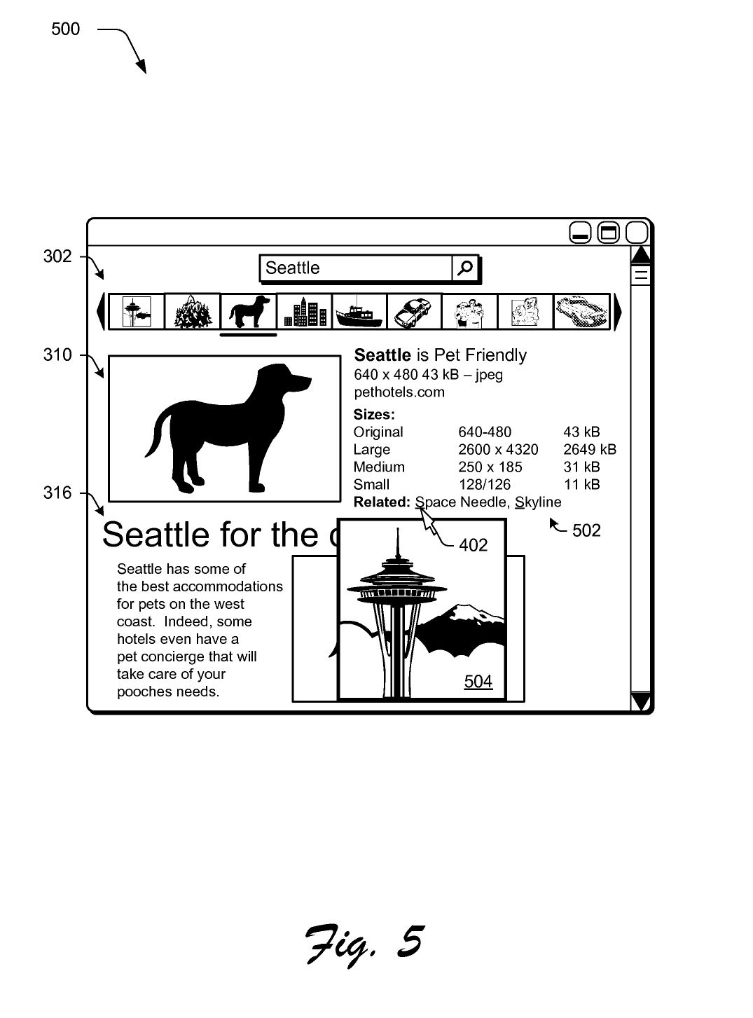

FIG. 5 is an illustration of a user interface 500 in an example implementation as displaying an image of a related image search result responsive to disposing a cursor over a link that is selectable to cause output of the related image search result. The user interface 500 includes links 502 to related searches that may be performed by selecting the link. The links 502, for instance, may be generated by the search service 102 based on groups of searches requested by users of the service.

In this instance, the user interface 500 is also illustrated as outputting a representative image 504 of a corresponding link responsive to “hovering” a cursor 402 over the link. For example, a user may position the cursor 402 over the link but not select the link. Thus, the image 504 may be output in a non-modal manner that does not involve actually selecting the link which may enable a user to view an image from the related search result without actually requesting the search. Further discussion of image search result display techniques may be found in relation to the following procedures.

Example Procedures

The following discussion describes image search result display techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the user interfaces 200-500 of FIGS. 2-5.

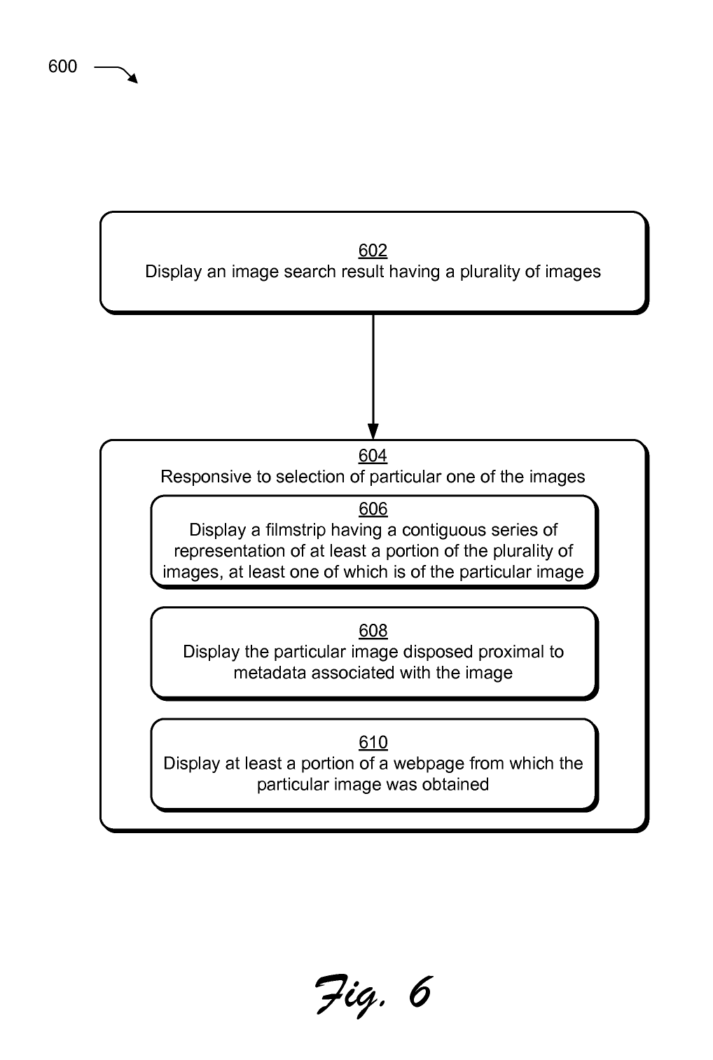

FIG. 6 depicts a procedure 600 in an example implementation in which an image search result is configured to include a filmstrip. An image search result is displayed having a plurality of images (block 602). For example, the client 104 may obtain the search result 112 from the search service 102 and display it, an example of which is shown in the user interface 200 of FIG. 2.

Responsive to selection of a particular one of the images (block 604), a filmstrip is displayed having a contiguous series of representations of at least a portion of the plurality of images, at least one of which is of the particular image (block 606). The particular image is also displayed proximal to metadata associated with the image (block 608) along with at least a portion of a webpage from which the particular image was obtained (block 610). As shown in the user interface 300 of FIG. 3, for instance, the filmstrip 302, image 310, and portion 316 of the webpage may be displayed concurrently in the user interface responsive to the selection of the image. Other implementations are also contemplated, such as non-concurrent display, display of the filmstrip initially without selection of the image, and so on.

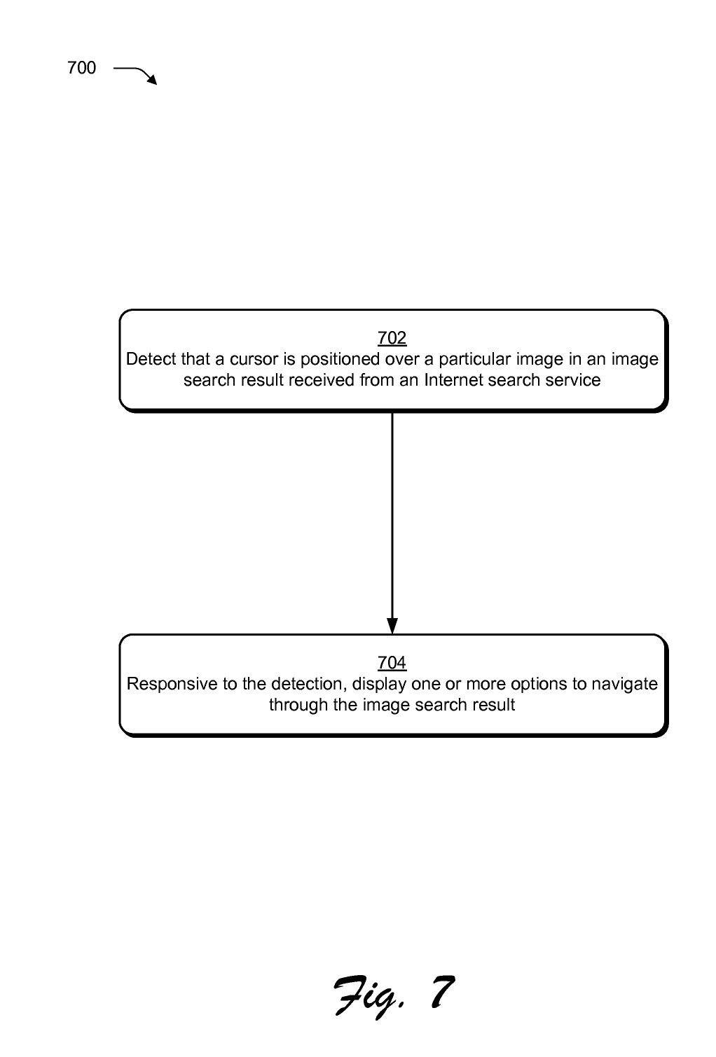

FIG. 7 depicts a procedure 700 in an example implementation in which one or more options to navigate through an image search result are displayed responsive to detection of positioning of a cursor over an image. A cursor is detected as positioned over a particular image in an image search result received from an Internet search service (block 702). A user of the client 104, for instance, may use a cursor control device (e.g., a mouse, gesture, and so on) to position a cursor 402 over a display of an image 310.

Responsive to the detection, one or more options are displayed to navigate through the image search result (block 704). The one or more options, for instance, may be displayed using non-modal techniques. One example of this was discussed in relation to FIG. 4, in which arrows are displayed responsive to positioning a cursor 402 within a boundary of a display of the image 310. A user may then select one or more of the options to navigate through images in an order that follows the displayed order in the filmstrip 302. Other examples of options that may be displayed to navigate through images are also contemplated.

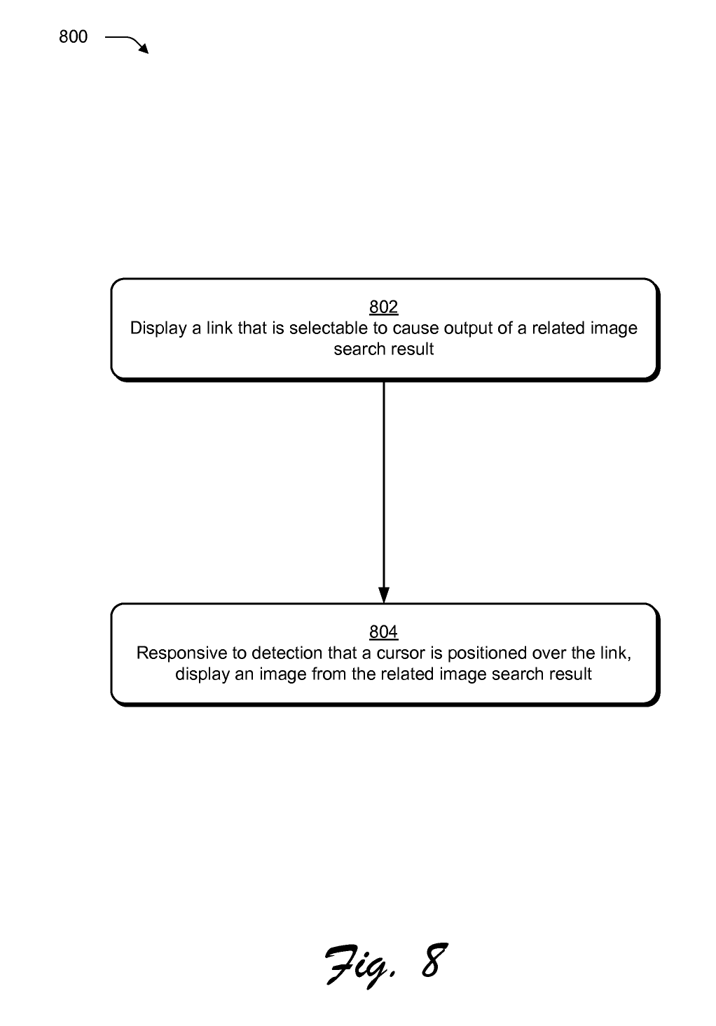

FIG. 8 depicts a procedure 800 in an example implementation in which an image from a related image search result is output in responsive to positioning a cursor over a link. A link is displayed that is selectable to cause output of a related image search result (block 802). As shown in the user interface 500 of FIG. 5, for instance, the links 502 may be displayed in conjunction with an image search result received from a search provider 102.

Responsive to detection that a cursor is positioned over the link, an image is displayed from the related image search result (block 804). The image 504 may be chosen to represent the related image search result and displayed without having a user actually select the link 502. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more modules, the method comprising:
displaying an image search result having a plurality of images; and
responsive to selection of a particular one of the images, displaying:
a filmstrip having a contiguous series of representations of at least a portion of the plurality of images, at least one of which is of the particular image;
the particular image disposed proximal to metadata associated with the image; and
at least a portion of a webpage from which the particular image was obtained.

2. A method as described in claim 1, wherein the one or more modules implemented by a client and the image search result is received by the client via a network from an internet search service.

3. A method as described in claim 1, wherein the particular image disposed proximal to the metadata is displayed larger than the representation of the particular image in the filmstrip.

4. A method as described in claim 1, wherein the filmstrip is associated with a display of arrows on opposing sides of the filmstrip that are selectable to navigate through the filmstrip in a corresponding direction.

5. A method as described in claim 4, wherein the navigation causes representations in the filmstrip to scroll.

6. A method as described in claim 5, wherein the scrolling is performable without changing the display of the particular image as display proximal to the metadata and the display of at least a portion of the webpage.

7. A method as described in claim 1, wherein the contiguous series of representations are contiguous in that the representations connect without a break.

8. A method as described in claim 1, further comprising:
detecting that a cursor is displayed over the particular image in the image search result; and
responsive to the detecting, displaying one or more options to navigate through the image search result automatically and without user intervention.

9. A method as described in claim 8, wherein the options are selectable to navigate through the filmstrip.

10. A method as described in claim 1, wherein the display of the particular image disposed proximal to the metadata is also disposed proximal to a plurality of options that are selectable to display the particular image in a respective different size than currently displayed.

11. A method as described in claim 1, wherein the displaying includes displaying an animation to fade out from the particular said image and fade in to another image responsive to selection of the other image.

12. A method implemented by one or more modules, the method comprising:
detecting that a cursor is positioned over a particular image in an image search result received from an Internet search service; and
responsive to the detecting, displaying one or more options to navigate through the image search result.

13. A method as described in claim 12, wherein the display of the one or more options is non-modal.

14. A method as described in claim 12, wherein the options are displayed within a boundary of the particular image.

15. A method as described in claim 12, further comprising displaying the image search result to include:
a filmstrip having a contiguous series of representations of at least a portion of the plurality of images, at least one of which is of the particular image;
the particular image disposed proximal to metadata associated with the image; and
at least a portion of a webpage from which the particular image was obtained.

16. A method as described in claim 15, wherein the image search result is displayed responsive to selection of the particular image from the plurality of images.

17. A method as described in claim 15, wherein the options are selectable to navigate through the filmstrip.

18. A method implemented by one or more modules, the method comprising:
displaying:
a filmstrip having a contiguous series of representations of at least a portion of a plurality of images of an image search result, at least one of which is of a particular image;
the particular image disposed proximal to metadata associated with the image, the particular image displayed larger than the representation of the particular image in the filmstrip;
at least a portion of a webpage from which the particular image was obtained; and
a link that is selectable to cause output of a related image search result; and
responsive to detection that a cursor is positioned over the link, displaying an image from the related image search result.

19. A method as described in claim 18, wherein the image from the related search result is displayed in conjunction with the image search result including the filmstrip, the particular image, and the portion of the webpage.

20. A method as described in claim 18, wherein the display of the image from the related image search result is non-modal.
